(19) United States
(12) Patent Application Publication
(10) Pub. No.: US 2002/0033797 A1
(43) Pub. Date: Mar. 21, 2002

(54) Method and apparatus for setting a parameter

(75) Inventors: Judith F.M. Masthoff, Brighton (GB); Ashok Gupta, Brighton (GB); Paul Zwart, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/954,640

(22) Filed: Sep. 18, 2001

(30) Foreign Application Priority Data
Sep. 20, 2000 (GB) 0023003.7

(51) Int. Cl. G09G 5/00

(52) U.S. Cl. 345/156

(57) ABSTRACT

A parameter is set to an accurate value, by voice control or manual input, by giving the commands Up, Down and Stop. The command “Up” increases the value of the parameter at a first speed; a subsequent command “Up” increases the value at a greater speed; alternatively a subsequent command “Down” decreases the value at a lower speed than the first speed. The parameter can be, for example, screen brightness or viewing angle in a medical domain, or channel in a multi-channel television set.

This invention relates to a method and apparatus for setting a parameter, that is to increasing or decreasing a parameter from its current value until a desired value is reached suitably, but not essentially, as a parameter setting or adjusting means operating in response to user input.

It is of course well known to set and/or adjust a parameter manually, by use of (for example) a slider or rotary knob potentiometer control or similar device, but, depending on the coarseness of the movement (i.e. the size and spacing of any incremental setting variations that may be made), precision setting may not be easy. One solution is to provide separate “coarse” and “fine” controls, but this increases complexity for the user and costs to the manufacturer.

An alternative arrangement is described in Patent Abstracts of Japan, publication number 07200239-A (NEC Corporation), in which the scrolling speed through items on a display screen is controlled by two buttons controlling movement in opposite directions. Speed, which increases the longer a button is continuously depressed, and direction are controlled by holding the buttons down, either singly or together, but complexity is introduced and precision setting may not be easy.

In some circumstances, manual setting is inconvenient or impossible, for example in a sterile medical or fabrication domain, or where an operator's hands are fully occupied with a different task. One solution to such problems is a so-called non-manual or “hands-free” set up, an example of which is set out in U.S. Pat. No. 5,850,211 (Sun Microsystems Inc), in which scrolling speed on a screen is controlled by detection of the position of a viewer's eyes, but complex equipment is needed and the control is limited to the screen being viewed.

It is an object of the invention to provide a method and apparatus for setting a parameter which allows precision setting without complexity, and which may be used non-manually.

According to a first aspect of the present invention, there is provided a method of changing the value of a parameter from a current value to a desired value comprising the steps of:-

inputting a first directional command to cause a parameter to vary at a first speed in a first direction; and

inputting a second directional command to cause the parameter to vary at a different speed either in the first direction or in the opposite direction.

With separate commands, a simple to learn and intuitive to operate mode of parameter setting is possible.

The second directional command is suitably a repeat of the first directional command which causes the parameter to vary in the first direction at a speed higher than the first speed. The second directional command may be different to the first directional command and cause the parameter to vary in the opposite direction at a lower speed than the first speed.

Optionally, there may be two possible directional commands corresponding to “Up” and “Down” whereby the parameter is increased or decreased in value. As a further variation, a third command may be supported corresponding to “Stop” which causes the parameter to retain its current value. In such a scheme, the steps may be supported of inputting a first directional command; inputting a stop command; and inputting a second directional command, whereby the parameter varies in the first direction at a slower speed than the first speed.

The commands are suitably voice commands, but may instead be manually input commands, or may be a combination of the two.

In accordance with a further aspect of the present invention there is provided an apparatus for changing the value of a parameter from a current value to a desired value comprising control means to control the parameter; and input means to which the control means in responsive; wherein the input means is arranged to input directional commands whereby the control means varies the parameter in response to a first directional command at a first speed in a first direction and then in response to a second directional command varies the parameter at a different speed in the first or in the opposite direction. Suitably, though not essentially, the input means is a voice recognition device.

The invention will now be described by way of example only with reference to the accompanying drawings in which:-

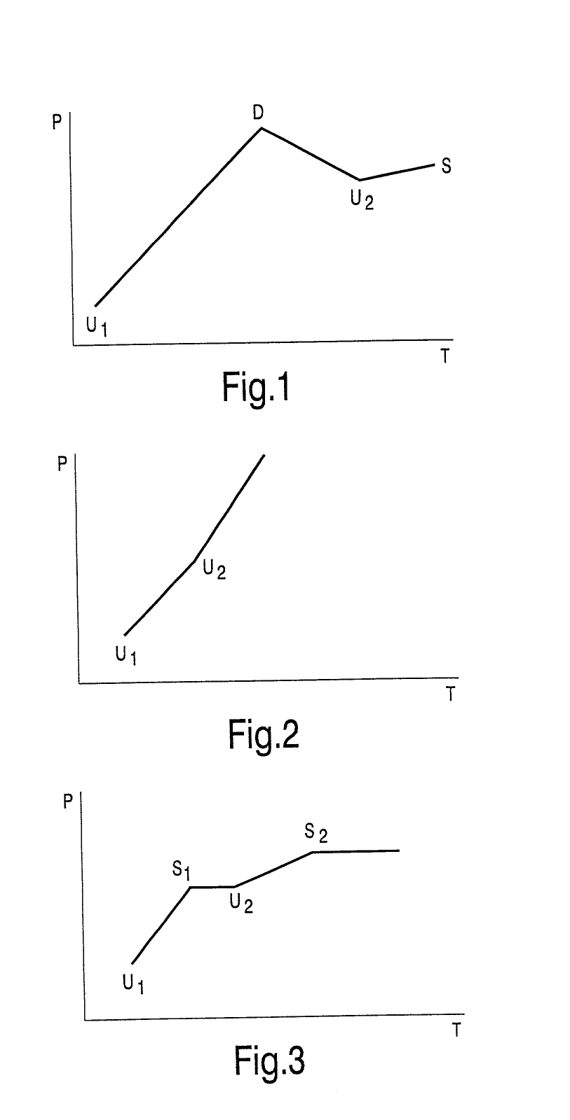

FIG. 1 illustrates the effect of input directional commands, according to the method of the invention, on the value of a parameter;

FIGS. 2 and 3 illustrate the effect of different combinations of input directional commands;

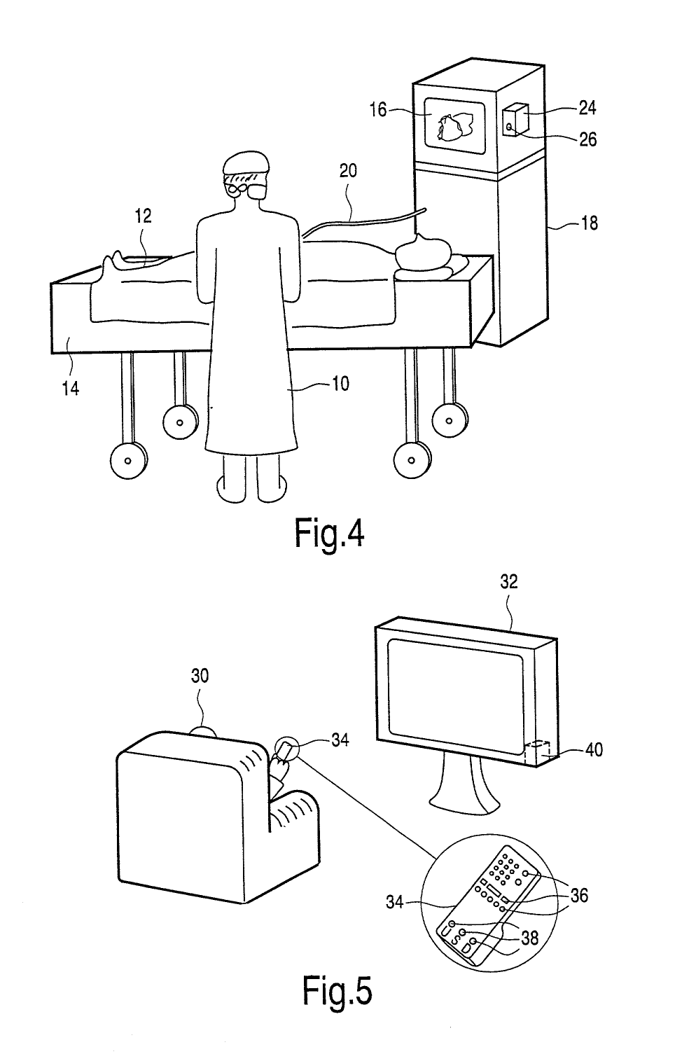

FIG. 4 illustrates the use of parameter setting by voice commands in a medical environment; and

FIG. 5 illustrates the use of manually input directional commands in a home environment.

FIGS. 1 to 3 illustrate the variation in value of a parameter P with time T. A user gives a command “Up” represented by U1, and the parameter increases at a predetermined rate, say five units per second. The user gives a command “Down” represented by D, and the parameter decreases at a slower rate, say three units per second; on the next command of “Up” at U2, the parameter increases again at a yet slower rate, say one unit per second. The assumption is that the second and third commands are given after the parameter has over-shot the required value, and subsequent approaches to the required value become slower and slower. When the required value is reached, the user gives the command “Stop” represented by S and the parameter remains at this value.

If the first command had been “Down”, then the parameter would first have decreased at the predetermined rate of five units per second; on the next command being “Up”, the parameter would then increase at the reduced rate of three units per second, and so forth.

If the rate of increase of the parameter after the first command at U1 is insufficiently fast, a repeated command of “Up” is arranged to increase the rate of change, say from five units per second to seven units per second. This is illustrated in FIG. 2.

In FIG. 3, the first command U1 is followed by a command “Stop”, S1, and the parameter remains constant; the next command U2 causes the parameter to increase again, but at a slower rate. In this example the required value of the parameter has not been over-shot. When the required value is reached, the command “Stop” S2 causes the parameter to remain at the required value.

Generalising, the algorithm to determine the value of X is as follows:-

S is an array of different speeds

Suppose S[i]>S[j] for all i>j

Invariant X=S[k]

If (last command is Up and current command=Up)

Then {k:=k+1; last direction command=Up;}

Else

If (last command is Down and current command=Down)

Then {k:=k+1; last direction command=Down;}

Else

If (last direction command is Up and current command=Down)

Then {k:=k −1; last direction command:=Down; last command:=Down}

Else

If (last direction command is Down and current command=Up)

Then {k:=k−1; last direction command:=Up; last command:=Up;}

Else

If (last command is Stop and last direction command=Up and current command=Up)

Then {k:=k−1; last command Up; last direction command Up;}

Else

If (last command is Stop and last direction command=Down and current command=Down)

Then {k:=k−1; last command Down; last direction command:=Down;}

Else

If current command=Stop

Then last command=Stop;

X:=S[k];

FIG. 4 illustrates the use of the invention in a medical environment when the commands are voice commands.

In an operating theater, a surgeon 10 performing keyhole surgery on a patient 12 on a trolley 14 is watching a display on a screen display 16 physically supported by electronic control equipment 18 which includes a light source and imaging means. The screen 16 is displaying a view of the operating area provided by a flexible connection 20, which supplies illumination in one direction and image information in the reverse direction between the operating area and the control equipment 18.

Adjacent the screen 16 is a voice recognition device 24 having a microphone 26. Before beginning the operation, the surgeon 10 trains the voice recognition device 24 to recognise his/her voice giving the commands “Up”, “Down” and “Stop”. These commands may be re-entered for each operation, or they may be stored for recall during subsequent operations by a given surgeon.

During the operation, the surgeon 10 uses the appropriate commands to control the brightness of the display on the screen 16. Alternatively, the commands could be used to change the focus of a camera viewing the area of operation, or the angle of the camera with respect to the area of operation.

It will be appreciated that voice activation can be arranged to be remote from the site at which the parameter is being varied; for example, in the FIG. 4 embodiment a supervisory surgeon at a remote site advising the surgeon who is actually performing the operation could use voice command control to position the camera viewing the site of the operation in accordance with his requirements.

In another embodiment the required parameter may be a discrete variable such as a television channel, i.e. the invention is used to step through the channels at a controllable speed, when a TV set has a very large number of channels.

In FIG. 5 a viewer 30 of a television set 32 having a multiplicity of channels has a hand-held infrared-operated TV channel selector 34. In addition to the conventional array of press-buttons 36, the selector 34 has three additional buttons 38 corresponding to Up, Down and Stop.

The viewer 30 uses the three buttons 38 to move through the multiplicity of channels available, with Up corresponding to an increased channel number and Down corresponding to a decreased channel number. The Stop button can be used both to initiate a slower approach to a desired channel and to stop the channel stepping when the desired channel is reached.

The selector 34 sends out an infrared signal as usual which is detected and interpreted by an infrared receiving circuit 40 in the TV set 32.

It will be appreciated that the method of the invention can be applied to any type of parameter, whether that parameter is continuous in nature, such as screen brightness, or positional in nature such as viewing angle, or is discreet in nature, such as a television channel.

1. A method of changing the value of a parameter from a current value to a desired value comprising the steps of:-
inputting a first directional command to cause the parameter to vary at a first speed in a first direction; and
inputting a second directional command to cause the parameter to vary at a different speed either in the first or in the opposite direction.

2. A method according to claim 1, in which the second directional command is a repeat of the first directional command which causes the parameter to vary in the first direction at a speed higher than the first speed.

3. A method according to claim 1, in which the second directional command is different to the first directional command and causes the parameter to vary in the opposite direction at a lower speed than the first speed.

4. A method according to claim 1, in which there are two possible directional commands corresponding to “Up” and “Down” whereby the parameter is increased or decreased in value.

5. A method according to claim 1, in which there is a third command corresponding to “Stop” which causes the parameter to retain its current value.

6. A method according to claim 5, comprising the steps of inputting a first command; inputting a stop command; and inputting a second command whereby the parameter varies in the first direction at a slower speed than the first speed.

7. A method according to claim 1, in which the commands are voice commands.

8. A method according to claim 1, in which the commands are manually input commands.

9. Apparatus for changing the value of a parameter from a current value to a desired value comprising control means to control the parameter; and input means to which the control means in responsive; wherein the input means is arranged to input directional commands whereby the control means varies the parameter in response to a first directional command at a first speed in a first direction and then in response to a second directional command varies the parameter at a different speed in the first or in the opposite direction.

10. Apparatus according to claim 9, in which the input means is a voice recognition device.
